(19) United States
(12) Patent Application Publication
(10) Pub. No.: US 2007/0291121 A1
(43) Pub. Date: Dec. 20, 2007

(54) Computer executable image quality detection system

(75) Inventors: Shu-Wen Chuang, Taipei (TW); Sheng-Fu Lan, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/455,099

(22) Filed: Jun. 19, 2006

(51) Int. Cl. H04N 17/00

(52) U.S. Cl. 348/181; 348/189

(57) ABSTRACT

A computer executable image quality detection system is provided, which comprises: a scaling symmetry testing unit, for testing the image scaling symmetry of an image signal; a luminance/chroma testing unit, for testing the separation of luminance and chroma of the image signal; a de-interlace testing unit, for testing the dynamic movement of the image signal; a color bar testing unit, for testing the color purity distinction of the image signal; a luminance compensation testing unit, for testing the Gamma compensation of the image signal; and a high/low frequency testing unit, for testing the high frequency and low frequency signal presentation of the image signal. By simultaneously executing the respective testing units, the producers' procedure and time for developing and testing are simplified and shortened.

### BACKGROUND OF THE INVENTION

1. Field of Invention

The present invention relates to a computer executable detection system, particularly to a computer executable image quality detection system.

2. Related Art

Presently, most instrument manufacturers will provide an image quality testing pattern, but the pattern may only perform testing analysis for a single image quality, and the testing functions provided are limited. Therefore, a relatively long testing time is necessary when developing and manufacturing display products, e.g. liquid crystal television or plasma television, etc.

Referring to Taiwan patent publication No. 554292, a method for detecting the reference position of a resolution testing diagram is disclosed, comprising: obtaining an image containing a largest dark portion in a resolution testing diagram by the use of an image capture device; calculating the length of the largest dark portion in this image; then dividing the image into several sections, wherein the area of each section is the square of the half length of the largest dark portion; calculating an average value of the pixel level of each section, so as to derive a darkest section with the lowest average value of pixel level; and finding out four bevel sections adjacent to the darkest section. However, the above method may only perform testing for resolution, and cannot provide other image quality testing functions.

Referring to Taiwan patent publication No. 1220689, a detection system and method of a display device are disclosed, which are used with a display. Such a display comprises a plurality of pixels each comprising a plurality of sub-pixels. The detection system mainly comprises a pattern generating device used for displaying specific patterns or colors on the display; a photoelectric sensing image capture device used for capturing the patterns displayed by the display as an image and outputting the image; and an image processing system used for processing the image output by the photoelectric sensing image capture device, to identify the abnormal pixels of the display; wherein, the pattern generating device may control the sequence patterns of a subgroup of pixels generated by the display sequentially, the subgroup of pixels generates different patterns at different time, each pixel point in each subgroup of pixels of each pattern only drives a certain subpixel light point in the pixel point at each time. However, the above method may only detect whether the pixels in a display are normal and without any flaw, but cannot provide other image quality testing functions.

Therefore, it has become one of the problems to be solved by researchers how to provide an image quality detection pattern to effectively simplify and shorten producers' procedure and time for developing and testing, and to reduce the risk and cost when display products are manufactured in bulk.

### SUMMARY OF THE INVENTION

In view of the above problems, a main object of the present invention is to provide an image quality testing pattern, wherein, the testing objects generated by various testing units perform testing for every requirement of image quality, thereby effectively simplifying and shortening producers' procedure and time for developing and testing.

Therefore, to achieve the above object, a computer executable image quality detection system disclosed by the preferred embodiments of the present invention comprises: a scaling symmetry testing unit, which generates image scaling symmetry testing object having a four-quadrant coordinate axis used, for testing the image scaling symmetry of an image signal, wherein there is a scale mark at each end of the four-quadrant coordinate axis for providing references for the correction and adjustment performed by testing operators, and the image scaling symmetry testing object further having an elliptical portion, for detecting whether its leftmost side, rightmost side, topmost side, and bottommost side can be fully presented in the displaying area of a screen; a luminance/chroma testing unit, which generates a luminance/chroma testing object disposed on the four-quadrant coordinate axis, for testing the separation of luminance and chroma of the image signal; a de-interlace testing unit, which generates an interlace/de-interlace testing object disposed on the four-quadrant coordinate axis, for testing the dynamic movement of the image signal, wherein the interlace/de-interlace testing object dynamically moves to any quadrant of the four-quadrant coordinate axis in the way of positive spin or reversed spin; a color bar testing unit, which generates a color bar testing object disposed on the four-quadrant coordinate axis, for testing the color purity distinction of the image signal; a luminance compensation testing unit, which generates a Gamma compensation testing object disposed on the four-quadrant coordinate axis, for testing the Gamma compensation of the image signal; and a high/low frequency testing unit, which generates a high/low frequency signal testing object disposed on the four-quadrant coordinate axis, for testing the high frequency and low frequency signal presentation of the image signal, wherein the high/low frequency signal testing object has a plurality of rectangular blocks each having a plurality of parallel lines, and the lines between the rectangular blocks have different thicknesses.

With this computer executable image quality detection system, the image quality of display products is tested by various testing objects, such as an image scaling symmetry testing object, a luminance/chroma testing object, an interlace/de-interlace testing object, a color bar testing object, a Gamma compensation testing object, and a high/low frequency signal testing object, to detect the display properties of image quality such as luminance, chroma, dynamic movement, color bar, luminance compensation, and signal presentation, thereby simplifying and shortening producers' procedure and time for developing and testing. Further, the testing objects are combined into a detection pattern, for further testing the coordination of image frames.

The characteristics and implementations related to the present invention will be illustrated in detail as follows with preferred embodiments accompanied with drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein-below for illustration only, and thus are not limitative of the present invention, and wherein:

FIG. 1 is a block diagram of a system according to a preferred embodiment of the present invention;

FIG. 2 is a schematic view of the combination of detecting objects according to a preferred embodiment of the present invention;

FIG. 3 is a schematic view of an image scaling symmetry testing object according to a preferred embodiment of the present invention;

FIG. 4A is a schematic view of a luminance/chroma testing object according to a preferred embodiment of the present invention;

FIG. 4B is a schematic view when the separation property of the luminance/chroma testing object in FIG. 4A is poor;

FIG. 5 is a schematic view of an interlace/de-interlace testing object according to a preferred embodiment of the present invention;

FIG. 6 is a partially magnified schematic view of the interlace/de-interlace testing object of FIG. 5;

FIG. 7A is a schematic view of a high/low frequency signal testing object according to a preferred embodiment of the present invention; and

FIG. 7B is a schematic view when the signal of the high/low frequency signal testing object in FIG. 7A is poor.

### DETAILED DESCRIPTION OF THE INVENTION

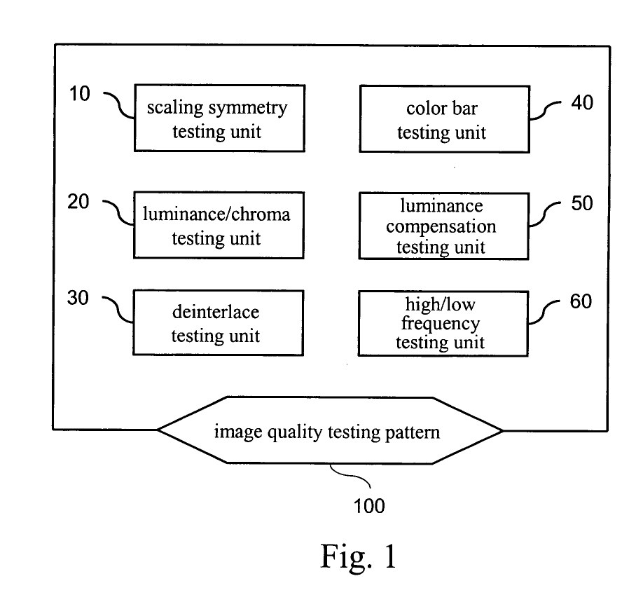

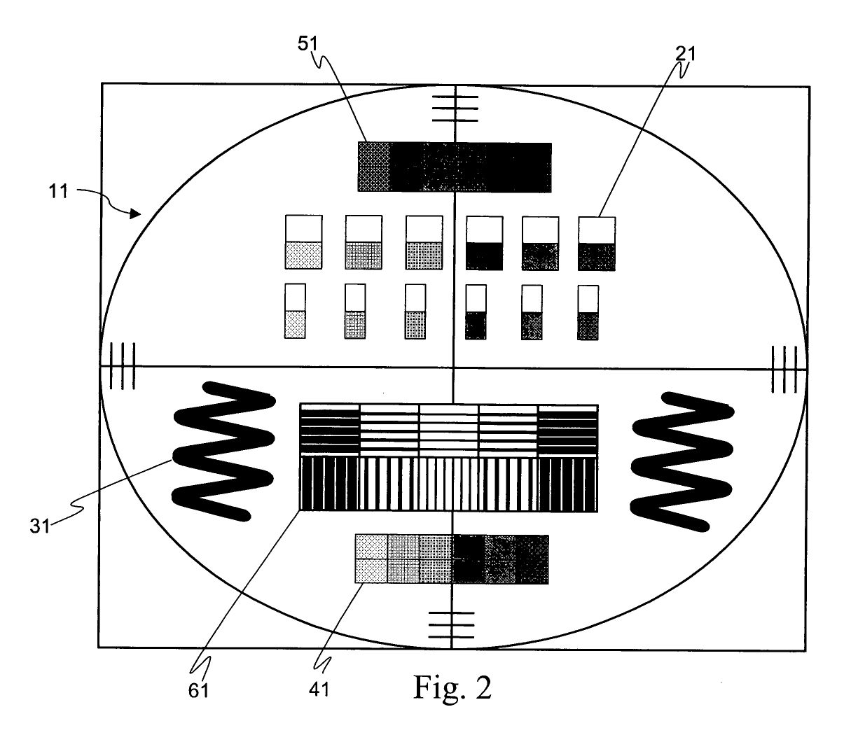

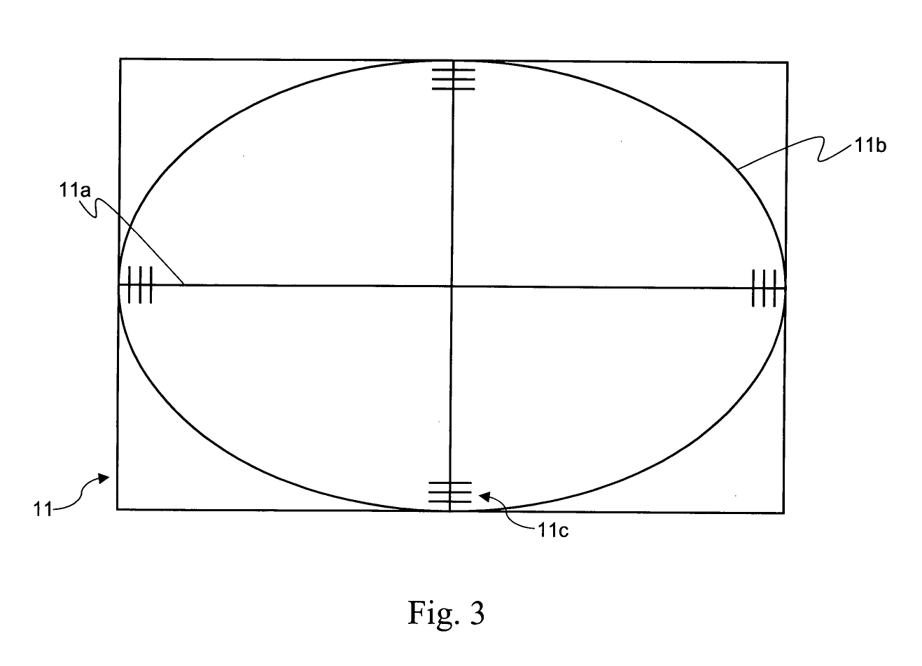

Referring to FIG. 1, it is a block diagram of a system according to a preferred embodiment of the present invention. An image quality detection system 100 comprises: a scaling symmetry testing unit 10, a luminance/chroma testing unit 20, a de-interlace testing unit 30, a color bar testing unit 40, a luminance compensation testing unit 50, and a high/low frequency testing unit 60. Further, FIG. 2 is a schematic view of the combination of detection objects according to a preferred embodiment of the present invention. The scaling symmetry testing unit 10 generates an image scaling symmetry testing object 11 having a four-quadrant coordinate axis 11a and an elliptical portion 11b, as shown in FIG. 3. When an image pattern corresponding to an image signal presents on the screen, the elliptical portion 11b is used to detect whether its leftmost side, rightmost side, topmost side, and bottommost side can be fully presented in the displaying area of the screen (not shown). A scale mark 11c is provided at each end of the four-quadrant coordinate axis 11a, which is used to provide references for the correction and adjustment performed by testing operators when the ratio of the testing frame is switched from 4:3 to 16:9, in order to confirm whether or not the image scaling is normal and in accordance with prescriptive quality.

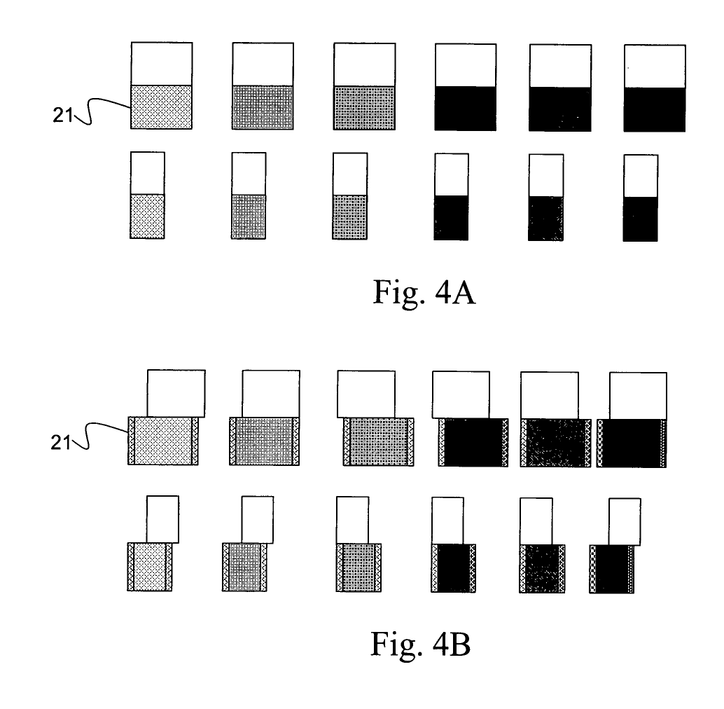

The luminance/chroma testing unit 20 generates a luminance/chroma testing object 21 disposed on the four-quadrant coordinate axis 11a and located between the Gamma compensation testing object 51 and the high/low frequency signal testing object 61. The luminance/chroma testing object 21 is formed by combining a plurality of white blocks and a plurality of blocks with colors from light to dark, and is used for testing the separation of luminance and chroma of the image signal, e.g. a composite signal CVBS, as shown in FIG. 4A. When the separation is poor, demitint will occur in the frame presented by the image pattern, or the non-synchronous transmission of the image signal after separation will occur, as shown in FIG. 4B.

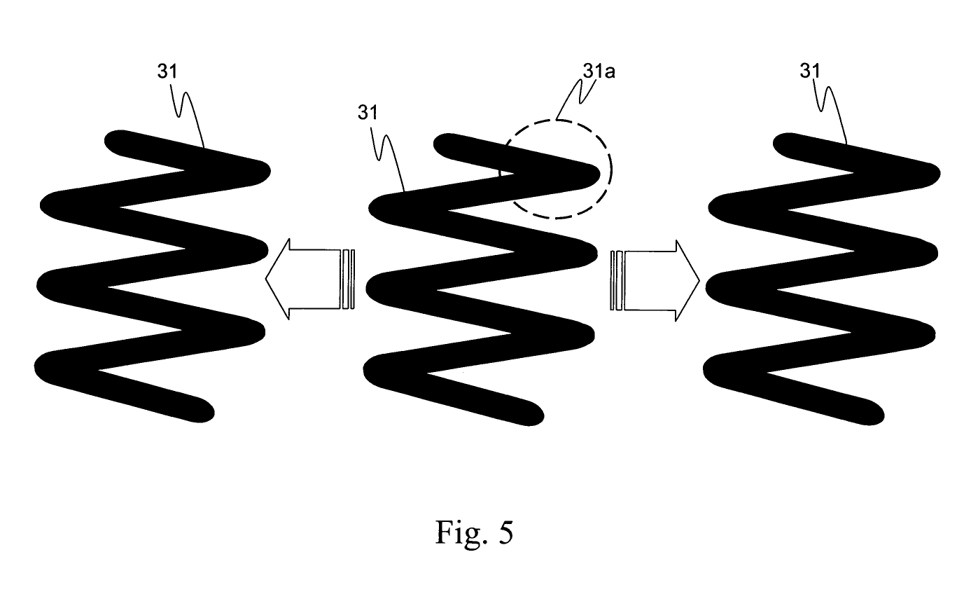

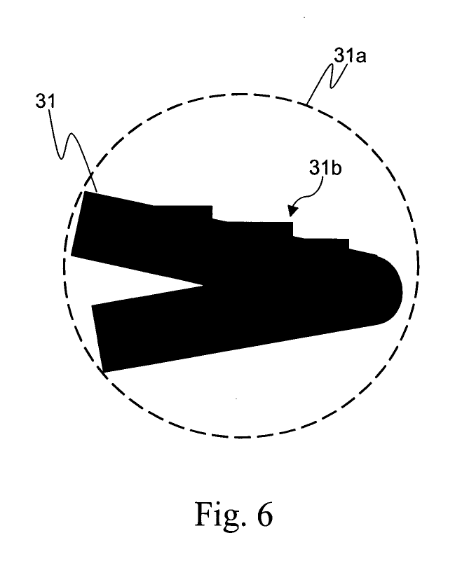

The de-interlace testing unit 30 generating an interlace/de-interlace testing object 31 is disposed on the four-quadrant coordinate axis 11a and adjacent to the high/low frequency signal testing object 61. It is used to test whether the pattern de-interlace occurs when the image pattern is dynamically moved. When the dynamic image is poorly processed, a sawtooth 31b will occur on the boundary 31a of the patterns of the interlace/de-interlace testing object 31, as shown in FIG. 6, wherein the interlace/de-interlace testing object 31 may positive spin, reversed spin or move in parallel in the direction of left, right, up, down, left top, left bottom, right top, right bottom, or other directions within the range of the four-quadrant coordinate, i.e. in any one quadrant. The design of the shape of its pattern boundary 31a is used mainly to facilitate testing operators to observe whether there is a pattern de-interlace. FIG. 5 is a schematic view of the movement of the interlace/de-interlace testing object 31. Further, two interlace/de-interlace testing objects 31 are taken as example in FIG. 2, and any one skilled in the related art may reduce or increase the number of objects.

The color bar testing unit 40 generates a color bar testing object 41 disposed on the four-quadrant coordinate axis 11a and adjacent to the high/low frequency signal testing object 61, as shown in FIG. 2. It has color blocks with different color bars arranged from light to dark, to test whether or not the color purity between colors is distinct, and whether or not the colors are mixed together or color purity errors occur.

The luminance compensation testing unit 50 generates a Gamma compensation testing object 51, and the Gamma compensation testing object 51 is disposed on the four-quadrant coordinate axis 11a, adjacent to the luminance/chroma testing object 21, as shown in FIG. 2. It has color blocks with different color bars, to provide the Gamma compensation property for testing the image signal or detect whether each bar between colors is distinct or not. The Gamma compensation testing object 51 is similar to the color bar testing object 41, but it has color bars with deeper colors, and the arranged positions and image patterns of the two objects may be exchanged.

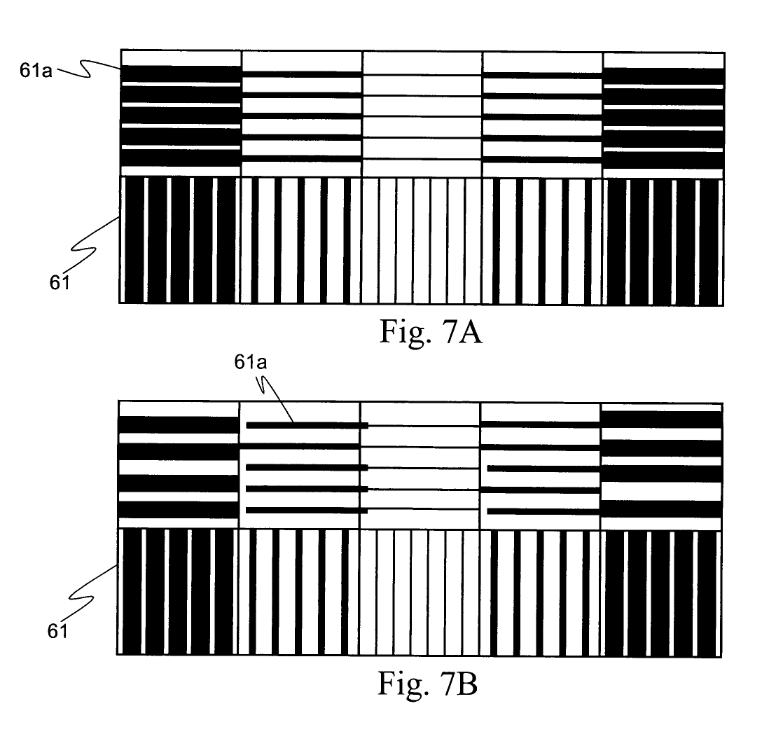

The high/low frequency testing unit 60 generates a high/low frequency signal testing object 61 disposed on the four-quadrant coordinate axis 10a, located between the luminance/chroma testing object 21 and the color bar testing object 41, as shown in FIG. 2 for testing the high frequency and the low frequency signal presentation of the image signal. And the high/low frequency signal testing object 61 has a plurality of rectangular blocks each having a plurality of lines 61 a arranged in parallel therein, wherein the lines 61a between the rectangular blocks have different thicknesses, as shown in FIG. 7A. FIG. 7B is a schematic view when the high frequency signal and the low frequency signal are poor. It can be found that, when the high frequency signal and the low frequency signal are poor, the arrangement of the lines 61 a in the rectangular blocks is seen to be disordered and dislocated.

With this computer executable image quality detection system, the image quality of display products is tested by testing objects generated by various testing units, such as an image scaling symmetry testing object, a luminance/chroma testing object, an interlace/de-interlace testing object, a color bar testing object, a Gamma compensation testing object, and a high/low frequency signal testing object, to detect display properties of image quality such as luminance, chroma, dynamic movement, color bar, luminance compensation, signal presentation, thereby simplifying and shortening the producers' procedure and time for developing and testing. Further, the testing objects are combined into a detection pattern, for further testing the coordination of image frames.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer executable image quality detection system, comprising:
a scaling symmetry testing unit, which generates an image scaling symmetry testing object having a four-quadrant coordinate axis, for testing the image scaling symmetry of an image signal;
a luminance/chroma testing unit, which generates a luminance/chroma testing object disposed on the four-quadrant coordinate axis, for testing the separation of luminance and chroma of the image signal;
a de-interlace testing unit, which generates at least one interlace/de-interlace testing object disposed on the four-quadrant coordinate axis, for testing the dynamic movement of the image signal;
a color bar testing unit, which generates a color bar testing object disposed on the four-quadrant coordinate axis, for testing color purity distinction of the image signal;
a luminance compensation testing unit, which generates a Gamma compensation object disposed on the four-quadrant coordinate axis, for testing the Gamma compensation of the image signal; and
a high/low frequency testing unit, which generates a high/low frequency signal testing object disposed on the four-quadrant coordinate axis, for testing the high frequency and low frequency signal presentation of the image signal;
wherein the testing objects are combined with each other into a detection pattern, for testing the frame coordination of the image signal.

2. The computer executable image quality detection system as claimed in claim 1, wherein the interlace/de-interlace testing object dynamically move to any quadrant of the four-quadrant coordinate axis.

3. The computer executable image quality detection system as claimed in claim 2, wherein the interlace/de-interlace testing object dynamically moves to any quadrant of the four-quadrant coordinate axis in a way of positive spin.

4. The computer executable image quality detection system as claimed in claim 2, wherein the interlace/de-interlace testing object dynamically moves to any quadrant of the four-quadrant coordinate axis in a way of reversed spin.

5. The computer executable image quality detection system as claimed in claim 1, wherein the image scaling symmetry testing object has an elliptical portion, for detecting whether its leftmost side, rightmost side, topmost side, and bottommost side can be fully presented in the displaying area of a screen.

6. The computer executable image quality detection system as claimed in claim 1, wherein the Gamma testing object further tests the distinction of each bar between colors of the image signal.

7. The computer executable image quality detection system as claimed in claim 1, wherein each end of the four-quadrant coordinate axis has a scale mark, for providing references for correcting frames.

8. The computer executable image quality detection system as claimed in claim 1, wherein the high/low frequency signal testing object has a plurality of rectangular blocks each having a plurality of parallel lines with different thicknesses, for testing the high frequency and the low frequency signal presentation correspondingly.
